(19) United States
(12) Patent Application Publication
(10) Pub. No.: US 2015/0158644 A1
(43) Pub. Date: Jun. 11, 2015

(54) MULTILAYER FILMS FORMED USING PRIMER COMPOSITIONS AND METHODS FOR MANUFACTURING THE SAME

(71) Applicant: Honeywell International Inc., Morristown, NJ (US)

(72) Inventor: Yuan-Ping R. Ting, Plainsboro, NJ (US)

(21) Appl. No.: 14/482,328

(22) Filed: Sep. 10, 2014

Related U.S. Application Data
(60) Provisional application No. 61/913,992, filed on Dec. 10, 2013.

(51) Int. Cl. B65D 65/42; B05D 7/00; B65D 30/08

(52) U.S. Cl. CPC B65D 65/42; B65D 31/02; B05D 7/52

(57) ABSTRACT

A multilayer film includes a) a thermoplastic polymer layer having a first surface and a second surface opposed to the first surface; b) a primer layer in contact with the first surface of the thermoplastic polymer layer, said primer layer including a fluoropolymer and a functionalized polymer; and c) a fluoropolymer layer having a first surface, and a second surface opposed to the first surface, the fluoropolymer layer being attached to the thermoplastic polymer layer such that the primer layer is positioned in contact with the first surface of the fluoropolymer layer and the first surface of the thermoplastic polymer layer.

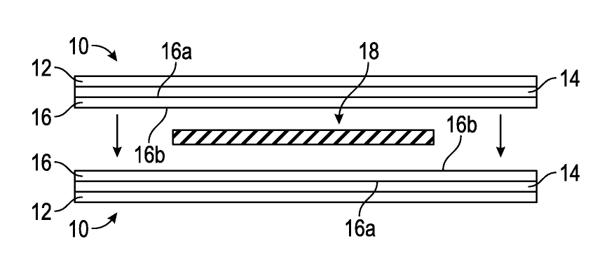

### CROSS-REFERENCE TO RELATED APPLICATIONS

This application claims the benefit of priority to U.S. provisional patent application Ser. No. 61/913,992, which was filed on Dec. 10, 2013, the contents of which are herein incorporated by reference in their entirety.

### TECHNICAL FIELD

The present disclosure generally relates to multilayer thermoplastic polymer films. More particularly, the present disclosure relates to multilayer thermoplastic polymer films having a primer composition and a fluoropolymer coating applied thereto.

### BACKGROUND

A wide variety of thermoplastic polymers and films formed from thermoplastic polymers are known in the art including, for example, polyethylene terephthalate (PET), polyethylene terephtalate glycol-modified (PETG), and polyvinyl chloride (PVC), and fluoropolymers, among others. Important physical characteristics of such films include their barrier properties, including barriers to gas, aroma, and/or vapor such as water vapor, as well as their physical characteristics, such as toughness, wear and weathering resistances, and light-transmittance. These properties and characteristics are especially important in film applications such as, for example, in the use of films as a packaging material for food or medical products.

It is well known in the art to produce single layer and multilayer fluoropolymer films. See, for example, U.S. Pat. Nos. 4,146,521; 4,659,625; 4,677,017; 5,139,878; 5,855,977; 6,096,428; 6,138,830; and 6,197,393. Many fluoropolymer materials are known in the art for their excellent moisture and vapor barrier properties, and therefore are desirable components of packaging films, particularly lidding films and blister packages. In addition, fluoropolymers exhibit high thermal stability and excellent toughness. However, such use of fluoropolymers is restricted to specialty packaging applications due to their relatively high cost. A suitable means of reducing the cost of a packaging material fabricated from a costly polymer is to form multilayer structures in which the polymer film is laminated with or coated with other, less costly polymer films. This approach is particularly desirable for the fluoropolymer packaging applications since a thin layer of the fluoropolymer is often all that is needed to take advantage of the desirable properties of the fluoropolymer while minimizing the cost.

Fluoropolymers, however, do not adhere strongly to most other polymers, thus making the manufacture of multilayer fluoropolymer films challenging. To improve the bond strength between a layer or coating of a fluoropolymer and a layer of a thermoplastic polymer (e.g., a non-fluoropolymer containing layer), an adhesive tie layer may be used between adjacent layers. For example, U.S. Pat. No. 4,677,017 discloses coextruded multilayer films which include at least one fluoropolymer film and at least one thermoplastic film which are joined by the use of an adhesive polymer, particularly ethylene/vinyl acetate polymers, as an adhesive tie layer. U.S. Pat. No. 4,659,625 discloses a fluoropolymer multilayer film structure which utilizes a vinyl acetate polymer adhesive tie layer. U.S. Pat. No. 5,139,878, discloses a fluoropolymer film structure using an adhesive tie layer of modified polyolefins. U.S. Pat. No. 6,451,925 teaches a laminate of a fluoropolymer containing layer and a non-fluoropolymer containing layer using an adhesive tie layer which is a blend of an aliphatic polyamide and a fluorine-containing graft polymer. Additionally, U.S. Pat. No. 5,855,977 teaches applying an aliphatic di- or polyamine to one or more surfaces of a fluoropolymer or non-fluoropolymer material layer. Due to the increased costs and the increased use of materials associated with using an adhesive tie coating to adhere fluoropolymer films to thermoplastic films, along with the increased chance for forming defects in the plastic film as the result of application of such adhesives, the use of multilayer fluoropolymer films has heretofore been largely limited to specialty applications.

Accordingly, it is desirable to provide compositions and methods that enable fluoropolymer coatings to adhere more strongly to thermoplastic films. It is further desirable to provide fluoropolymer coated thermoplastic films and methods for the manufacture thereof at reduced cost and with a reduced incidence of defects as compared to the use of conventional tying adhesives. Furthermore, other desirable features and characteristics of the disclosed embodiments will become apparent from the subsequent detailed description and the appended claims, taken in conjunction with the accompanying drawings and this background.

### BRIEF SUMMARY

Thermoplastic polymer films having a primer composition and a fluoropolymer coating applied thereto are disclosed. In one exemplary embodiment, a multilayer film includes a) a thermoplastic polymer layer having a first surface and a second surface opposed to the first surface; b) a primer layer in contact with the first surface of the thermoplastic polymer layer, said primer layer including a fluoropolymer and a functionalized polymer; and c) a fluoropolymer layer having a first surface, and a second surface opposed to the first surface. In the embodiment, the fluoropolymer layer is attached to the thermoplastic polymer layer such that the primer layer is positioned in contact with the first surface of the fluoropolymer layer and the first surface of the thermoplastic polymer layer.

In some embodiments, the multilayer film may be employed as a packaging article, and the packaging article may enclose a packaged product.

In another exemplary embodiment, a process for producing a multilayer film includes the steps of a) providing a thermoplastic polymer layer having a first surface, and a second surface opposed to the first surface; b) applying an primer layer onto the first surface of the thermoplastic polymer layer, said primer layer including a fluoropolymer and a functionalized polymer; and c) applying a fluoropolymer layer, having a first surface, and a second surface opposed to the first surface, to the thermoplastic polymer layer, such that the primer layer is positioned in contact with the first surface of the fluoropolymer layer and the first surface of the thermoplastic polymer layer.

### BRIEF DESCRIPTION OF THE DRAWING

The present embodiments will hereinafter be described in conjunction with the following drawing FIGURE, wherein like numerals denote like elements, and wherein:

The FIGURE is a schematic representation of a fluoropolymer coated thermoplastic film in accordance with various embodiments encasing a product.

### DETAILED DESCRIPTION

The following detailed description is merely exemplary in nature and is not intended to limit the application and uses of the embodiment described. Furthermore, there is no intention to be bound by any theory presented in the preceding background or the following detailed description.

Referring to the FIGURE, in accordance with an exemplary embodiment, a multilayer film 10 includes a fluoropolymer coating layer 12 coated on a thermoplastic polymer film layer 16. These layers are adhered to one another by an intermediate primer layer 14. Primer layer 14 imparts excellent bond strength between adjacent layers of the multilayer film, and particularly between the fluoropolymer coating layer 12 and the thermoplastic polymer film layer 16.

In the production of the multilayer film 10 of the illustrated embodiment, primer layer 14 is coated on the thermoplastic polymer film layer 16, and the fluoropolymer coating layer 12 is coated on the primer layer 14. The thermoplastic polymer film layer 16 has first and second opposed surfaces 16a and 16b, respectively. The primer layer 14 is coated onto the first opposed surface 16a, and the second opposed surface 16b is left uncoated. Moreover, in packaging applications, the second opposed surface 16b is placed in abutting contact with a packaged article 18, as shown in the FIGURE. The fluoropolymer coating layer 12 is thereafter coated over the primer layer 14.

### Thermoplastic Polymer Films

Suitable thermoplastic polymer materials suitable for use as the film layer 16 are now provided. These materials include, for example, polyolefin homopolymers, polyolefin copolymers, cyclic olefin homopolymers, cyclic olefin copolymers, ethylene vinyl acetate copolymers, polyesters such as polyethylene terephthalate, polyamides, polyvinyl chloride, polyvinylidene chloride, polystyrene, styrenic copolymers, polyisoprene, polyurethanes, ethylene ethyl acrylate, ethylene acrylic acid copolymers, and mixtures thereof. The thermoplastic polymer layer 16 may also include another fluoropolymer layer.

Suitable polyolefins for use as the thermoplastic polymer layer 16 include polymers of alpha-olefin monomers having from about 3 to about 20 carbon atoms and include homopolymers, copolymers (including graft copolymers), and terpolymers of alpha-olefins. Illustrative homopolymer examples include low density polyethylene (LDPE), ultra low density polyethylene (ULDPE), linear low density polyethylene (LLDPE), metallocene linear low density polyethylene (m-LLDPE), medium density polyethylene (MDPE), and high density polyethylene (HDPE), polypropylene, polybutylene, polybutene-1, poly-3-methylbutene-1, poly-pentene-1, poly-4,4 dimethylpentene-1, poly-3-methyl pentene-1, polyisobutylene, poly-4-methylhexene-1, poly-5-ethylhexene-1, poly-6-methylheptene-1, polyhexene-1, polyoctene-1, polynonene-1, polydecene-1, polydodecene-1, and a combination thereof.

Illustrative polyolefin copolymers and terpolymers for use as the thermoplastic polymer layer 16 include copolymers and terpolymers of alpha-olefins with other olefins such as ethylene-propylene copolymers; ethylene-butene copolymers; ethylene-pentene copolymers; ethylene-hexene copolymers; and ethylene-propylene-diene copolymers (EPDM). The term polyolefin as used herein also includes acrylonitrilebutadiene-styrene (ABS) polymers, copolymers with vinyl acetate, acrylates and methacrylates and the like. Preferred polyolefins are those prepared from alpha-olefins, most preferably ethylene polymers, copolymers, and terpolymers. The above polyolefins may be obtained by any known process. The polyolefin may have a weight average molecular weight of about 1,000 to about 1,000,000, and preferably about 10,000 to about 500,000 as measured by high performance liquid chromatography (HPLC). Preferred polyolefins are polyethylene, polypropylene, polybutylene and copolymers, and blends thereof. The most preferred polyolefin is polyethylene. The most preferred polyethylenes are low density polyethylenes, commonly referred to in the art as “LDPE.”

Suitable polyamides for use as the thermoplastic polymer layer 16 non-exclusively include homopolymers or copolymers selected from aliphatic polyamides and aliphatic/aromatic polyamides having a weight average molecular weight of from about 10,000 to about 100,000. General procedures useful for the preparation of polyamides are well known to the art. Useful polyamide homopolymers include poly(4-aminobutyric acid) (nylon 4), poly(6-aminohexanoic acid) (nylon 6, also known as poly(caprolactam)), poly(7-aminoheptanoic acid) (nylon 7), poly(8-aminooctanoic acid)(nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), nylon 4,6, poly(hexamethylene adipamide) (nylon 6,6), poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12), and the like. Useful aliphatic polyamide copolymers include caprolactam/hexamethylene adipamide copolymer (nylon 6,6/6), hexamethylene adipamide/caprolactam copolymer (nylon 6/6,6), trimethylene adipamide/hexamethylene azelaiamide copolymer (nylon trimethyl 6,2/6,2), hexamethylene adipamide-hexamethylene-azelaiamide caprolactam copolymer (nylon 6,6/6,9/6), and a combination thereof. Also included are other nylons which are not particularly delineated here. Of these polyamides, preferred polyamides include nylon 6, nylon 6,6, nylon 6/6,6 as well as mixtures of the same. Of these, nylon 6 is most preferred.

Aliphatic polyamides for use as the thermoplastic polymer layer 16 may be obtained from commercial sources or prepared in accordance with known preparatory techniques. For example, poly(caprolactam) can be obtained from Honeywell International Inc., Morristown, N.J., USA. Exemplary of aliphatic/aromatic polyamides include poly(tetramethylenediamine-co-isophthalic acid) (nylon 4,1), polyhexamethylene isophthalamide (nylon 6,1), hexamethylene adipamide/hexamethylene-isophthalamide (nylon 6,6/6I), hexamethylene adipamide/hexamethyleneterephthalamide (nylon 6,6/6T), poly (2,2,2-trimethyl hexamethylene terephthalamide), poly(m-xylylene adipamide) (MXD6), poly(p-xylylene adipamide), poly(hexamethylene terephthalamide), poly(dodecamethylene terephthalamide), polyamide 6T/6I, polyamide 6/MXDT/I, polyamide MXDI, and the like. Blends of two or more aliphatic/aromatic polyamides can also be used. Aliphatic/aromatic polyamides can be prepared by known preparative techniques or can be obtained from commercial sources. Other suitable polyamides are described in U.S. Pat. Nos. 4,826,955 and 5,541,267, which are incorporated herein by reference.

### Fluoropolymer Coating

With attention now to the fluoropolymer coating layer 12, as initially noted, fluoropolymer materials are commonly known for their excellent chemical resistance and release properties as well as moisture and vapor barrier properties, and therefore are desirable components of packaging films. In preferred embodiments, the fluoropolymer coating layer 12 may include fluoropolymer homopolymers or copolymers or blends thereof as are well known in the art and are described in, for example, U.S. Pat. Nos. 4,510,301, 4,544,721 and 5,139,878. Preferred fluoropolymers include, but are not limited to, homopolymers and copolymers of chlorotrifluoroethylene, ethylene-chlorotrifluoroethylene copolymer, ethylene-tetrafluoroethylene copolymer, fluorinated ethylene-propylene copolymer, perfluoroalkoxyethylene, polychlorotrifluoroethylene, polytetrafluoroethylene, polyvinyl fluoride, polyvinylidene fluoride, and copolymers and mixtures thereof. As used herein, copolymers include polymers having two or more monomer components. The most preferred fluoropolymers include homopolymers and copolymers of poly(chlorotrifluoroethylene). Exemplary PCTFE (polychlorotrifluoroethylene homopolymer) materials are sold under the ACLON™ and ACLAR® trademarks and PCTFE films formed therefrom, which are commercially available from Honeywell International Inc. of Morristown, N.J., USA.

In a preferred embodiment, the fluoropolymer coating layer 12 includes a chlorotrifluoroethylene/vinylidene fluoride (CTFE/VDF) copolymer layer. As noted above, the layer 12 is formed by a coating process over the thermoplastic film 16 (and over the primer layer 14). Accordingly, a CTFE/VDF copolymer coating composition and method for making such a composition is now provided. The preferred copolymer coating composition includes a chlorotrifluoroethylene component and a vinylidene fluoride component, the vinylidene fluoride component including from about 5% by weight to about 25% by weight of said copolymer coating composition, and preferably from about 15% to about 20% by weight. Methods for preparing CTFE/vinylidene fluoride copolymers are known in the art. See, for example, U.S. Pat. No. 5,453,477 which describes a method for the production of PCTFE/VDF resin suspensions using a catalyst system including t-butylhydroperoxide, sodium-m-bisulfite, and iron (II) sulfate hydrate. Furthermore, U.S. Pat. No. 5,955,556 describes an improvement to the process of U.S. Pat. No. 5,453,477 using a surfactant free emulsion polymerization method.

Copolymers of CTFE and vinylidene fluoride are commonly produced via either suspension or emulsion polymerization processes. The CTFE/VDF copolymer compositions having about 5% by weight to about 25% by weight of the VDF moiety, from which the films and articles of the disclosure are formed, are preferably polymerized by conventional free-radical polymerization methods. Any commercially available radical initiator may be used in the present disclosure. Suitable candidates include thermal initiators and oxidation-reduction or “redox” initiator systems. Thermal initiators include: metal persulfates such as potassium persulfate and ammonium persulfate; organic peroxides or hydroperoxides such as diacyl peroxides, ketone peroxides, peroxyesters, dialkyl peroxides and peroxy ketals; azo initiators such as 2,2′-azobisisobutyronitrile and water-soluble analogues thereof; and mixtures thereof.

Generally, any redox initiator system known to be useful in the preparation of fluoropolymers such as PCTFE may be used in the present disclosure. Typical redox initiator systems include: 1) an organic or inorganic oxidizing agent or mixtures thereof; and 2) an organic or inorganic reducing agent or mixtures thereof. Suitable oxidizing agents include metal persulfates such as potassium persulfate and ammonium persulfate; peroxides such as hydrogen peroxide, potassium peroxide, ammonium peroxide, tertiary butyl hydroperoxide (“TBHP”) ((CH₃)₃COOH)), cumene hydroperoxide, and t-amyl hydroperoxide; manganese triacetate; potassium permanganate; ascorbic acid, and mixtures thereof. Suitable reducing agents include sodium sulfites such as sodium bisulfite, sodium sulfite, sodium pyrosulfite, sodium-m-bisulfite (“MBS”) (Na₂S₂O₅) and sodium thiosulfate; other sulfites such as ammonium bisulfite; hydroxylamine; hydrazine; ferrous irons; organic acids such as oxalic acid, malonic acid, citric acid, and mixtures thereof.

The preferred free radical initiating system is one that serves to simultaneously emulsify the polymer while initiating the polymerization, thus eliminating the need for large quantities of surfactants. Redox initiator systems are the preferred radical initiator. Preferred redox initiator systems use an MBS reducing agent and a TBHP oxidizing agent. In a more preferred embodiment, the redox initiator system is used in conjunction with a transition metal accelerator. Accelerators can greatly reduce the polymerization time. Any commercially available transition metal may be used as an accelerator. Preferred transition metals include copper, silver, titanium, ferrous iron and mixtures thereof. Ferrous iron is most preferred.

The amount of radical initiator used in the process depends on the relative ease with which the various monomers copolymerize, the molecular weight of the polymer and the rate of reaction desired. Generally, from about 10 to about 100,000 ppm of initiator may be used, although from about 100 to about 10,000 ppm is preferred.

Optionally, in order to further accelerate the polymerization, the redox initiator system may include additional peroxide-based compounds. The amount of additional peroxide-based compound used ranges from about 10 to about 10,000 ppm and preferably from about 100 to about 5,000 ppm. The radical initiator may be added before, simultaneous with and/or shortly after the addition and/or consumption of the monomers used to make the copolymer. When an additional peroxide-based compound is used it may be added at the same interval specified for the primary radical initiator.

A preferred process for the preparation of the CTFE/VDF copolymers of the present disclosure is described in commonly owned U.S. Pat. No. 6,759,131, which is incorporated herein by reference. U.S. Pat. No. 6,759,131 describes a polymerization reaction in which monomers, water and an initial charge of radical initiator are introduced into suitable polymerization vessel. Additional monomer is added throughout the reaction at a rate equal to the rate of consumption to maintain a constant pressure. Incremental additional charges of initiator are introduced into the vessel over the duration of the reaction to sustain the polymerization. The reaction mixture is maintained at a controlled temperature while all reactants are being charged to the vessel and throughout the polymerization reaction.

The only requirement for the reaction vessel used to prepare the CTFE/VDF copolymer is that it be capable of being pressurized and agitated. Conventional commercial autoclaves which can be sealed and pressurized to the required reaction pressures (preferably less than 3.36 MPa (500 psig) for safety considerations) are preferred. Horizontally inclined autoclaves are preferred to vertically inclined autoclaves, although both geometries can be used. Preferably, the reactor vessel is lined with a fluoropolymer or glass liner.

The aqueous medium in which the polymerization is conducted is preferably deionized, nitrogen-purged water. Generally, an amount equivalent to approximately half the capacity of the autoclave is used. The ratio of polymer to water is chosen in such a way to obtain a dispersion of about 20 to about 60% polymer solids in water. The water is pre-charged to the autoclave.

The monomers may be charged to the reactor vessel either in a semicontinuous or a continuous manner during the course of the polymerization. “Semicontinuous” means that a number of batches of the monomers are charged to the reactor during the course of the polymerization reaction. In the preferred embodiment of the disclosure, the chlorotrifluoroethylene and vinylidene fluoride components are added to the reactor vessel at a CTFE:VDF weight ratio of from about 3:1 to about 19:1, more preferably from about 10:1 to about 19:1, and most preferably from about 15:1 to about 19:1.

The molar ratio of total monomer consumed to radical initiator will depend upon the molecular weight desired. Preferably, the overall mole ratio of monomer to initiator would be from about 10 to about 10,000, more preferably from about 50 to about 1,000, and most preferably from about 100 to about 500 moles of total monomer to one mole of initiator.

The radical initiator is generally added incrementally over the course of the reaction. For purposes of this discussion, “initial charge” or “initial charging” of initiator refers to a rapid, large, single or incremental addition of initiator to effect the onset of polymerization. In the initial charge, generally between about 10 ppm/min to about 1,000 ppm/min is added over a period of from about 3 to about 30 minutes, either before, after, or during the charging of the monomers. “Continuous charge” or “continuous charging” means the slow, small, incremental addition of initiator over a period of from about 1 hour to about 6 hours, or until polymerization has concluded. In the continuous charge, generally between about 0.1 ppm/min to about 30 ppm/min of initiator is added.

During the initiation of the polymerization reaction, the sealed reactor and its contents are maintained at the desired reaction temperature, or alternately to a varying temperature profile which varies the temperature during the course of the reaction. Control of the reaction temperature is another important factor for establishing the final molecular weight of the chlorofluoropolymers produced. As a general rule, polymerization temperature is inversely proportional to product molecular weight. Typically, the reaction temperature should range between about 0° C. to about 150° C., although temperatures above and below these values are also contemplated. The reaction pressure is preferably between from about 172 KPa to about 5.5 MPa, and more preferably from about 345 KPa to about 4.2 MPa. Elevated pressures and temperatures will yield greater reaction rates.

The polymerization is preferably conducted under agitation to ensure proper mixing. Although the agitation rate and reaction time will typically depend upon the amount of CTFE:VDF product desired, one of ordinary skill in the art can readily optimize the conditions of the reaction. The agitation rate will generally be in the range of from about 5 to about 800 rpm and, preferably from about 25 to about 700 rpm, depending on the geometry of the agitator and the size of the vessel. The reaction time will generally range from about 1 to about 24 hours, and preferably from about 1 to about 8 hours.

The CTFENDF copolymers produced using the above process are self-emulsifiable chlorofluorinated macromolecules having inorganic, “surfactant-like” functional end groups that impart excellent latex stability to the polymer when present in very low concentration. The CTFENDF copolymers produced are thereby dispersed in the aqueous medium by the attachment of these inorganic fragments onto the end of the polymer repeating units, thus creating a surface active agent having both a hydrophobic component and a hydrophilic component. This attachment leads to micelle formation, or, if the concentration of functionalized end groups is high enough, to their complete dissolution in water.

The type of “surfactant-like” end groups produced depends upon the type of initiator system selected and the optional addition of compounds that might be incorporated into the polymer through chain transfer reactions. Examples of such emulsifying function end groups include, but are not limited to, sulfonates, carboxylates, phosphonates, phosphates and salts and acids thereof, ammonium salts and any mixture thereof.

The presence of sulfonic acid end groups most significantly affect the emulsification of the chlorofluoropolymers in water. The amount of these functional end groups in the dispersion can be determined by first purifying the dispersion by methods known to the art, such as by ion exchange or dialysis, titrating the dispersion with any known base such as aqueous sodium hydroxide or ammonium hydroxide, and then expressing the amount in terms of molar equivalents of titrated base. The amount of these functional end groups expressed in moles of equivalent NaOH may range between from about 0.0001 to about 0.5 moles of functional end groups per liter of chlorofluoropolymer dispersion obtained. The molar ratio of these functional end groups per fluoropolymer produced may range from about 1:10 to 10,000, preferably from about 1:10 to 1,000 and more preferably from about 1:50 to 500. A typical CTFE/VDF copolymer dispersion contains about 0.01 molar equivalents/kg of dry polymer.

Dispersions prepared using a surfactant-free emulsion process obtain stable dispersions having up to 40 weight % solids in water, which is obtained without a concentration step. Low levels of surfactants may be added to obtain higher levels of emulsified polymer in water (i.e., 40-60 weight %). Suitable surfactants will readily occur to those skilled in the art and include anionic, cationic and nonionic surfactants. The preferred dispersion is an anionic surfactant stabilized latex emulsion having from 0 to 0.25 weight % of an anionic emulsifier.

Perfluorinated anionic surfactants are preferred. Examples of suitable perfluorinated anionic surfactants include perfluorinated ammonium octanoate, perfluorinated alkyl/aryl ammonium (metal) carboxylates and perfluorinated alkyl/aryl lithium (metal) sulfonates wherein the alkyl group has from about 1 to about 20 carbon atoms. Suitable surfactants also include fluorinated ionic or nonionic surfactants, hydrocarbon-based surfactants such as the alkylbenzenesulfonates or mixtures of any of the foregoing.

The chlorofluoropolymers produced by the above process may be isolated by conventional methods such as evaporating the water medium, freeze-drying the aqueous suspension, or adding a minor amount of an agglomerating or coagulating agent such as ammonium carbonate, followed by filtration or centrifuging. Alternatively and preferably the chlorofluoropolymer dispersion produced is used as is.

Depending upon the application desired, other components may also be included, such as wetting and leveling agents such as octylphenoxypolyethoxyethanol; pigments such as titanium dioxide; thickeners such as hydrophobe modified alkali swellable emulsions (HEURASE); defoamers; UV absorbers; plasticizers such as butyl benzylphthalate; biocides; fillers such as glass beads from 0.1-200 microns in size, as well as nanospheres; stain resists such as aqueous PTFE or fine powder PTFE; and the like. See, e.g., Handbook of Organic Coatings: A Comprehensive Guide for the Coatings Industry (NY 1990) or Handbook of Coatings Additives, (NY 1987). Other suitable processes for the formation of CTFE/VDF copolymers of the disclosure are also described in commonly owned U.S. Pat. Nos. 5,880,204 and 6,140,408, which are incorporated herein by reference.

As stated above, the CTFE/VDF copolymers from which the coated fluoropolymer coating layer 12 is formed preferably include about 5% by weight to about 25% by weight of said vinylidene fluoride component. More preferably, the CTFE/VDF copolymer includes from about 15% by weight to about 20% by weight of said vinylidene fluoride component, and more preferably from about 15% to about 17.5% of said vinylidene fluoride component.

Regarding the method of application of the fluoropolymer coating composition, in one embodiment, the fluoropolymer coating composition is coated over the primer layer 14 in multi-pass processes, although a single-pass process may also be used. Spray and roller application are the most convenient application methods. Other well-known coating methods including dipping and coil coating are suitable. The fluoropolymer compositions may be applied as a single coat or as a multiple number of coats. The dried film thickness, DFT, of a single coat will be typically at least 35 μm, preferably at least 40 μm, and more preferably at least about 50 μm. Generally the maximum single pass coating thickness is about 60 μm. With the fluoropolymer coatings described herein it is possible to apply a number of coating layers to reach thicknesses of greater than 100 μm, for example greater than 300 μm, and even as high as 1 mm, if desired. The application process is able to occur at ambient temperatures, for example from about 20° C. to about 30° C. Thereafter, the multi-layer film 10 may be allowed to dry. Drying may be performed at an elevated temperature to increase the speed at which the film dries, for example from about 70° C. to about 120° C. The drying process may also be expedited with air or nitrogen. Thereafter, the application process can be repeated any number of times to produce the desired thickness of coating, for example one, two, three, four, five, or more times.

### Primer Layer

Reference will now be made to the primer layer 14 in accordance with various exemplary embodiments of the present disclosure. As initially noted, the present disclosure provides multilayer films having a coated fluoropolymer layer that can robustly adhere to a thermoplastic polymer film layer and methods for making such multilayer films. Accordingly, the primer layer 14 is provided as an applied coating to the thermoplastic polymer film layer 16 in order to allow the subsequently coated fluoropolymer layer to adhere robustly thereto. Greater detail regarding the primer layer 14 and the composition thereof is now provided. The primer layer 14 includes an aqueous coating composition that includes both a fluoropolymer material and a functionalized polymer material. The primer composition incorporates the functionalized polymer and the fluoropolymer in an aqueous coating composition such that the functionalized polymer is dispersed throughout the fluoropolymer to form a homogeneous composition.

By itself, the fluoropolymer has a relatively low surface energy due to its lack of functionality, e.g., lack of functional groups other than the fluorine. Therefore, the fluoropolymer has low adhesive properties. It has been discovered, however, that the functionalized polymer, when incorporated with the fluoropolymer in an aqueous coating composition increases the adhesion of the surface of the fluoropolymer coating layer 12 to the surface of the thermoplastic polymer film layer 16. In an exemplary embodiment, the functionalized polymer contains one or more functional groups, such as, for example, a carbonyl moiety, a carboxylic acid moiety, an amine moiety, a hydroxyl moiety, mixtures thereof, and the like, that can form bonds, e.g., chemical or covalent bonds, with another material. The inventors have found that if the functionalized polymer is present in an relatively small but effective amount in the primer composition, the concentration of the functionalized polymer at the surface of the fluoropolymer coating layer 12 is suitable for forming bonds with the thermoplastic polymer material to robustly adhere the thermoplastic polymer material to the fluoropolymer layer without diminishing the desirable properties (e.g. barrier properties, etc.) of the coated fluoropolymer coating layer 12.

In an exemplary embodiment, the composition of the primer layer 14 may be provided as follows. The fluoropolymer, which may include the CTFE/VDF copolymer as prepared and described above, is present in an amount from about 28% to about 85%, with a preferred range of about 39% to about 75%, and with a most preferred range of about 50% to about 60%, of the primer composition. Alternatively, the fluoropolymer may be polychlorotrifluoroethylene, ethylene-chlorotrifluoroethylene copolymer, polyvinylidene fluoride, tetrafluoroethylene-perfluoro (alkyl vinyl ether) copolymer, tetrafluoroethylene-hexafluoropropylene copolymer, and tetrafluoroethylene-ethylene copolymer, and mixtures thereof. Other fluoropolymers known to those skilled in the art may also be used.

In an exemplary embodiment, the functionalized polymer is present in an amount of about 15 to about 72%, preferably from about 25% to about 61%, and most preferably from about 40% to about 50%, of the primer composition. The functionalized polymer includes, but is not limited to, methacrylate polymers such as copolymers of ethylene-gycidyl methacrylate and terpolymers of ethylene-acrylic ester-gycidyl methacrylate, polyurethanes, terpolymers of ethylene-acrylic ester-maleic anhydride including terpolymers of ethylene-ethyl acrylate-maleic anhydride, alkyl ester copolymers, modified polyolefins, and mixtures thereof. The gycidyl methacrylate polymers including the copolymers of ethylene-gycidyl methacrylate and the terpolymers of ethylene-acrylic ester-gycidyl methacrylate, and the terpolymers of ethylene-acrylic ester-maleic anhydride including the terpolymers of ethylene-ethyl acrylate-maleic anhydride, are commercially available under the trade name Lotader® resins, which are manufactured by Arkema Inc. located in Philadelphia, Pa., USA.

The alkyl ester copolymers include copolymers of an olefin having about 2 to about 8 carbon atoms and an α,β-ethylenically unsaturated carboxylic acid having the following formula:

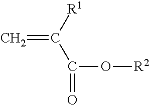

wherein R¹ is H or an alkyl group having 1 to 5 carbon atoms, and R² is H or an alkyl group having 1 to 12 carbon atoms.

The alkyl ester copolymers may be produced in accordance with the processes well known in the art including forming random, block, and graft copolymers. Those production processes include, but are not limited to, the ones described in U.S. Pat. No. 3,350,372 issued to Anspon (“Anspon”). As disclosed in Anspon, the alkyl ester copolymers in accordance with the present disclosure can be prepared by a continuous polymerization of an olefin of about 2 to about 8 carbon atoms and an alkyl ester of an α,β-ethylenically unsaturated carboxylic acid in the presence of a free radical polymerization initiator such as lauroyl peroxide or capryl peroxide. The olefins that may be used to form the alkyl ester copolymers include olefins having between 2 and 8 carbon atoms. Non-limiting examples of suitable olefins include ethylene, propylene, butylene, pentene-1,3-methylbutene-1,4-methylpentene-1, and hexene. Preferably, the olefins are ethylene, propylene, and butylene, and most preferably the olefin is ethylene.

The alkyl esters of an α,β-ethylenically unsaturated carboxylic acid that may be used to form the alkyl ester copolymers include, but are not limited to, methyl acrylate, ethyl acrylate, butyl acrylate, 2-ethylhexyl acrylate, decyl acrylate, octadecyl acrylate, methyl methacrylate, ethyl metacrylate, butyl methacrylate, 2-ethylhexyl methacrylate, decyl methacrylate, and octadecyl methacrylate. Of these, the preferred are methyl acrylate, ethyl acrylate, butyl acrylate, methyl methacrylate, ethyl methacrylate, and butyl methacrylate, and more preferred are methyl acrylate, methyl methacrylate, butyl acrylate, and butyl methacrylate.

Non-limiting examples of the alkyl ester copolymers that may be used include ethylene-methyl acrylate, ethylene-ethyl acrylate, ethylene-butyl acrylate, ethylene-2-ethylhexyl acrylate, ethylene-decyl acrylate, ethylene-octadecyl acrylate, ethylene-methyl methacrylate, ethylene-ethyl methacrylate, ethylene-butyl methacrylate, ethylene-2-ethylhexyl methacrylate, ethylene-decyl methacrylate, ethylene-octadecyl methacrylate, and copolymers and mixtures thereof. Of these, the preferred are ethylene-methyl acrylate, ethylene-ethyl acrylate, ethylene-butyl acrylate, ethylene-methyl methacrylate, ethylene-ethyl methacrylate, ethylene-butyl methacrylate, and copolymers and mixtures thereof including ethylene-methyl acrylateethylene-butyl acrylate copolymer. Of these, the more preferred are ethylene-methyl acrylate, ethylene-methyl methacrylate, ethylene-butyl acrylate, ethylene-butyl methacrylate, and copolymers and mixtures thereof. The preferred alkyl ester copolymer includes from about 5 to about 50 wt. % of the alkyl ester, based on the total weight of the alkyl ester copolymer. More preferably, the alkyl ester includes from about 5 to about 40 wt. %, and most preferably from about 10 and about 30 wt. %, based on the total weight of the alkyl ester copolymer.

In an exemplary embodiment, the primer composition has a portion of fluoropolymer coating along with functional end groups from both a urethane and an acrylic acid coating. The primer formula has excellent adhesion to plastic films (PET, PETG, PVC) due to the portion of the urethane and the acrylic acid. It also has excellent adhesion to water-base fluoropolymer coatings due the portion of the fluoropolymer coating in the primer.

Regarding the method of application of the primer coating composition, in one embodiment, the primer coating composition is coated over the thermoplastic polymer film layer 16 in multi-pass processes, although a single-pass process may also be used. Spray and roller application are the most convenient application methods. Other well-known coating methods including dipping and coil coating are suitable. The primer compositions may be applied as a single coat or as a multiple number of coats. The dried film thickness, DFT, of a single coat will be typically at least 0.2 μm, preferably at least 0.5 μm, and more preferably at least about 0.9 μm. Generally the maximum single pass coating thickness is about 11 μm. The application process is able to occur at ambient temperatures, for example from about 20-30° C. Thereafter, the multi-layer film 10 may be allowed to dry. Drying may be performed at an elevated temperature to increase the speed at which the film dries, for example from about 70-120° C. The drying process may also be expedited with air or nitrogen. Thereafter, the application process can be repeated any number of times to produce the desired thickness of primer coating, for example one, two, three, four, five, or more times.

### Multilayer Films

Referring back to the structure of the multilayer films 10, the multilayer films 10 described herein may further include at least one additional polymer layer (not shown) that may be attached on either the outer surface of the fluoropolymer coating layer 12 or the outer surface of the thermoplastic polymer layer 16, or both. Said at least one additional polymer layer may include a layer of any material described herein, but is by no means limited to such materials. For example, said optional additional layers may include a layer of a fluoropolymer, a polyamide, a polyolefin such as a polyethylene, an ethylene vinyl acetate copolymer, a polyester such as polyethylene terephthalate, polyvinyl chloride, polyvinylidene chloride, a polyurethane, polystyrene, a styrenic copolymer, an ethylene acrylic acid copolymer, a cyclic olefin homopolymer or copolymer, and mixtures thereof. The multilayer film may optionally include a plurality of additional layers. Each optional additional layer is preferably attached to the multilayer film via another poly(ester-urethane) copolymer primer layer 14 described herein, or via an primer layer of any other composition which is capable of adhering to a fluoropolymer layer. Such suitable adhesive materials non-exclusively include those described in U.S. Pat. No. 6,887,334, the disclosure of which is incorporated herein by reference, and also blends including a tackifier, ethylene-α-olefin copolymer, and optionally a styrenic block copolymer.

Each of the fluoropolymer coating layer 12, primer layer 14, thermoplastic polymer film layer 16 (and any optional layers) may optionally also include one or more conventional additives whose uses are well known to those skilled in the art. The use of such additives may be desirable in enhancing the processing of the compositions as well as improving the products or articles formed therefrom. Examples of such include: oxidative and thermal stabilizers, lubricants, release agents, flame-retarding agents, oxidation inhibitors, oxygen scavengers, dyes, pigments and other coloring agents, ultraviolet light absorbers and stabilizers, anti-microbial agents, organic or inorganic fillers including particulate and fibrous fillers, reinforcing agents, nucleators, plasticizers, as well as other conventional additives known to the art. Such may be used in amounts, for example, of up to about 30% by weight of the overall layer composition. Representative ultraviolet light stabilizers include various substituted resorcinols, salicylates, benzotriazoles, benzophenones, and the like. Representative anti-microbial agents include silver ion based anti microbial agents, triclosan (5-chloro-2-(2,4-dichlorophenoxy) phenol), thiabendazole, OPBA (10,10′-oxybisphenoxarsine) based anti-microbial agents, isothiazolinone and zinc pyrithione, as well as any antimicrobial agent that can be absorbed by pigment, pigment extenders or inorganic materials, such as zeolites or molecular sieves. These anti-microbial agents are generally not approved for use in food and drug applications and should only be used for industrial applications. Suitable lubricants and release agents include wax, stearic acid, stearyl alcohol, and stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Period Table of Element's Group I metal halides, such as sodium halides, potassium halides, lithium halides; as well as cuprous halides; and further, chlorides, bromides, iodides. Also acceptable are hindered phenols, hydroquinones, aromatic amines as well as substituted members of those above mentioned groups and mixtures thereof. Exemplary plasticizers include lactams such as caprolactam and lauryl lactam, sulfonamides such as o,p-toluenesulfonamide and N-ethyl, N-butyl benylenesulfonamide, and combinations of any of the above, as well as other plasticizers known to the art. The films may further have printed indicia on or between layers. Such printing is typically on an internal surface of the structure and methods of application are well known in the art.

The addition of one or more of the above optional additives may advantageously broaden the utility of the multilayer films of the disclosure. For example, the blending of one or more anti-microbial additives into one or more of the above layers may produce films that are highly effective for use as protective packaging films for products that are highly sensitive to atmospheric conditions. Such applications include archival bags, cigar bags, photograph storage bags, etc. Additives such as oxidation inhibitors or oxygen scavengers are advantageous in forming bags for storing and packaging of food, as well as bottles for storing beverages.

Although each layer of the multilayer film structure may have a different thickness, the fluoropolymer coating layer 12 has a preferred thickness of from about 12 μm to about 150 μm, more preferably from about 15 μm to about 100 μm, and most preferably from about 25 μm to about 50 μm. The thermoplastic polymer film layer 16 has a preferred thickness of about 12 μm to about 100 μm, a more preferred thickness of from about 25 μm to about 75 μm, and most preferably from about 25 μm to about 50 μm. The primer layer 14 has a preferred thickness of from about 0.13 μm to about 5.05 μm, more preferably from about 0.25 μm to about 2.5 μm and most preferably from about 0.60 μm to about 1.25 μm. Additional layers preferably have a thickness of from about 2.5 μm to about 100 μm, more preferably from about 7.5 μm to about 75 μm and most preferably from about 12.5 μm to about 25 μm. While such thicknesses are referenced, it is to be understood that other layer thicknesses may be produced to satisfy a particular need and yet fall within the scope of the present disclosure.

The multilayer films of this disclosure are useful as flat structures or can be formed, such as by thermoforming, into desired shapes. The films are useful for a variety of end applications, such as for medical packaging, pharmaceutical packaging, packaging of other moisture sensitive products and other industrial uses. The multilayer films of the disclosure are useful for forming thermoformed three dimensionally shaped articles such as tubes, bottles, and as blister packaging for pharmaceuticals or any other barrier packaging applications. This may be done by forming the film around a suitable mold and heating in a method well known in the art.

As illustrated in the FIGURE, packages and encased articles of the disclosure are preferably formed such that the thermoplastic polymer layer 16 includes the innermost film layer or layers positioned to contact a product 18. For example, a product 18 may be encased or encapsulated between two multilayer films 10 of the disclosure, wherein the thermoplastic polymer layer 16 of a first film 10 is attached to the thermoplastic polymer layer of a second film 10. While the FIGURE illustrates two separate films 10 being used to encase product 18, it should be understood that a single film 10 may be suitably used to form a package structure by simply cutting the multilayer film to a desired size and folding the film onto itself to form an overlap having an open top edge and open side edges, followed by sealing the top and side edges of the overlap, typically with heat and pressure, to form a package. Such techniques are conventionally understood by those skilled in the art. Optionally, a locking polymeric zipper may be incorporated into the package, allowing the package to be opened and sealed easily.

The overlapping layers or surface portions may be sealed together using any conventional means in the art. One preferred method of attachment is the use of an adhesive. Suitable adhesives for bag formation non-exclusively include any of the adhesive materials described herein, as well as polyurethanes, pressure sensitive adhesives (PSAs), epoxies and the like. However, in the most preferred embodiment of the disclosure, thermoplastic polymer layer 16 includes a material that is heat sealable, particularly heat sealable to itself under conventional heat sealing conditions without requiring an adhesive.

The heat sealing process forms a strong interlayer bond between film surfaces. Heat sealing techniques are well known in the art, and involve the application heat to melt and fuse portions of the polymer layer together. Heat sealing temperatures will vary depending on the properties of the particular thermoplastic polymer layer 16. However, not all polymeric films are heat sealable. In general, heat seal temperatures preferably range from about 150° C. to about 400° C., more preferably from about 175° C. to about 230° C., and heat seal pressures range from about 10 psia to about 100 psia, more preferably from about 40 psi to about 100 psi.

The moisture vapor transmission rate (MVTR) of such films in accordance with the present disclosure may be determined via the procedure set forth in ASTM F1249. In a preferred embodiment, the overall multilayer film according to this disclosure has a MVTR of from about 1.0 or less g/100 in²/day (15.5 g/m²/day) of the overall film at 37.8° C. and 100% relative humidity (RH), preferably from 0.0005 to about 0.7 g/100 in²/day (0.0077 to about 10.7 g/m²/day) of the overall film, and more preferably from about 0.001 to about 0.06 g/100 in²/day (0.015 to about 0.93 g/m²/day) of the overall film, as determined by water vapor transmission rate measuring equipment available from, for example, Mocon.

The oxygen transmission rate (OTR) of the films of the disclosure may be determined via the procedure of ASTM D-3985 using an OX-TRAN 2/20 instrument manufactured by Mocon, operated at 25° C., 0% RH. In the preferred embodiment, the overall multilayer film according to this disclosure has an OTR of from about 50 or less cc/100 in²/day (775 g/m²/day), preferably from about 0.001 to about 20 cc/100 in²/day (0.015 to about 310 g/m²/day), and more preferably from about 0.001 to about 10 cc/100 in²/day (0.015 to about 150 cc/m²/day).

### Illustrative Examples

The present disclosure is now illustrated by the following non-limiting examples. It should be noted that various changes and modifications can be applied to the following examples and processes without departing from the scope of this invention, which is defined in the appended claims. Therefore, it should be noted that the following examples should be interpreted as illustrative only and not limiting in any sense.

Various primer compositions were prepared in accordance with the foregoing disclosure. The primer compositions include an aqueous coating composition that includes both a fluoropolymer material and a functionalized polymer material. The primer composition incorporates the functionalized polymer dispersion and the fluoropolymer dispersion in an aqueous coating composition such that the functionalized polymer is dispersed throughout the fluoropolymer to form a homogeneous composition.

Four functionalized polymer dispersions (A-D) were tested, including the following:

Functionalized Dispersion “A” (Table 1): A mixture of Ethylene Acrylic Acid (EAA), and Polyurethane Dispersion. Final solid at 31.6% solid EAA dispersion—Michem® Flex HS-100 from Michelman Inc., Cincinnati, Ohio. It is a EAA dispersion with excellent adhesion to Polyester film. Polyurethane Dispersion—Stahl RU40-439 from Stahl USA, Peabody, Mass. It is waterborne, polyester urethane dispersion with excellent adhesion to a variety of rigid and flexible substrates.

TABLE 1
Functionalized Dispersion “A” Composition
CW (lb/ream) 3.50
Mixture Solid (%) 31.60%

| | | Raw Sol- | Mixing | Wt % | Dry wt % |
|---|---|---|---|---|---|
| | Content | id (%) | Parts | in Mix | in Coating |
| Chemical A | Stahl RU-40- | 40.0% | 30.0 | 30.00% | 38.0% |
| | 439 | | | | |
| Chemical B | Michelman | 28.0% | 70.0 | 70.00% | 62.0% |
| | EAA | | | | |
| | Dispersion | | | | |
| | MFHS-100 | | | | |
| Chemical C | Water | 0.0% | 0.0 | 0.00% | 0.0% |
| | | | | 0.00% | |
| | | | 100.0 | 100.0% | 100.0% |

Functionalized Dispersion “B” (Table 2): Polyester coating—Bostik Vitel 1577200 from Bostik Inc., Middleton, Mass. It is thermoplastic, high molecular weight, aromatic, linear saturated polyester resin. Vitel 1577200 can form a stable aqueous dispersion up to 30%. The polyester coating has great adhesion to both Polyester (corona treated), and PVC (corona treated) film. The example is based on 27% Vitel 1577200 dispersion in water.

TABLE 2
Functionalized Dispersion “B” Composition
CW (lb/ream) 3.50
Mixture Solid (%) 27.00%

| | | Raw Sol- | Mixing | Wt % | Dry wt % |
|---|---|---|---|---|---|
| | Content | id (%) | Parts | in Mix | in Coating |
| Chemical A | Bostik | 100.0% | 27.0 | 27.00% | 100.0% |
| | Vitel1577200 | | | | |
| Chemical B | Water | 0.0% | 73.0 | 73.00% | 0.0% |
| Chemical C | | 0.0% | 0.0 | 0.00% | 0.0% |
| | | | | 0.00% | |
| | | | 100.0 | 100.0% | 100.0% |

Functionalized Dispersion “C” (Table 3): Polyurethane dispersion—DSM NeoRez® R-960 from DSM Coating Resins Netherlands. NeoRez® R-960 is an air dry, water-borne urethane, specifically designed for high performance uses, where hardness, flexibility, chemical and abrasion resistance are required. It has excellent adhesion to PC (Polycarbonate) film.

TABLE 3
Functionalized Dispersion “C” Composition
Source DSM NeoRez 960
Mixture Solid (%) 30.00%

| | | Raw Sol- | Mixing | Wt % | Dry wt % |
|---|---|---|---|---|---|
| | Content | id (%) | Parts | in Mix | in Coating |
| Chemical A | DSM | 33.0% | 100.0 | 90.91% | 100.0% |
| | NeoRez 960 | | | | |
| Chemical B | Water | 0.0% | 10.0 | 9.09% | 0.0% |
| | | | | 0.00% | |
| | | | 110.0 | 100.0% | 100.0% |

Functionalized Dispersion “D” (Table 4): Polyurethane Dispersion—Stahl RU40-439 from Stahl USA, Peabody, Mass. Solids %: 40%.

Two fluoropolymer dispersions were tested, name the fluoropolymer dispersion “400A” and the fluoropolymer dispersion “FE-4300,” as described below:

Fluoropolymer Dispersion “400A”: CTFE and VDF copolymer at 83.5 to 16.5 monomer ratio that polymerizes in water and is available from Honeywell International Inc of Morristown, N.J., USA. The 400A dispersion has final solid at 48% with no functionality of —OH (hydroxyl), or —COOH (carboxyl) in the polymer. The 400A has no adhesion to plastic film including PET, PVC, PC, PP, LDPE, and others.

Fluoropolymer Dispersion “FE-4300”: Lumiflon® FE-4300 fluoropolymer dispersion from AGC Chemicals Americas, Exton, Pa. FE-4300 is a water emulsion product with final solid at 50%. Due to the low —OH (hydroxyl) functionality, FE-4300 has poor adhesion to both PET and PVC film.

Four thermoplastic film substrates were employed in testing the adhesion of the primer compositions. These include: 1. PET film—5 mil DuPont Melinex® ST505 biaxial oriented PET with both sides corona treated; 2. PVC film—10 mil corona treated PVC film from Klockner Barrier Film, Gordonsville, Va.; 3. PC film—5 mil polycarbonate film received from Tekra Corporation, New Berlin, Wis.; the PC film is under the trade name Lexan from SABIC with surface corona treatment; and 4. DuPont Surlyn® film —2 mil Surlyn® cast film made from DuPont Surlyn® resin; Surlyn® film has high adhesion to most of the coatings; the testing replaced 3M 610 pressure sensitive tape test with the Surlyn heat seal to coating test to measure coating adhesion.

Coating application was measured in accordance with the following standard: The standard unit for the dry coating weight on Plastic film is lb/ream or gram/m². 1 ream is equal to 3000 ft². The testing used lb/ream for the evaluation. The measurement method is based on weight subtraction method. Thus, the testing procedure weighed the sample with and without the coating at fix area using 4 decimal analytical balance. The weight difference per fix sample area is translated back to lbs/ream for the dry coating weight.

Adhesion testing was performed in accordance with the following testing procedure: Place 2 mil DuPont Surlyn® film on top of the coated film (PET, PVC, PC, for example) with coating facing the Surlyn® film. Using a thermal heat sealer with temperature setting at 350° F., dwell time 2 seconds, pressure 60 psi, heat seal the Surlyn® to the coating side of the film. Then pull back the Surlyn® from the coated film to determine the failure mode. If the coating stays with the original film, score 100 for good coating to film adhesion. If partial or all coating sticks on the Surlyn side, score 0 for poor coating to film adhesion. If the Surlyn applies on two layers of coating (primer coating plus fluoropolymer coating), determine whether fluoropolymer or primer coating failure based on the same score system.

In accordance with the foregoing testing procedure, primer compositions including various ratios of functionalized dispersion “A” and fluoropolymer dispersion “400A” were tested for adhesion. The testing and results are summarized in Table 4.

TABLE 4
400A/Dispersion A
Primer Adhesion Evaluation based on 400A and Functional A dispersion

| | | | | | | | | Final Mixture Dry | |
|---|---|---|---|---|---|---|---|---|---|
| | | | | | | | | Coating Evaluation | |
| | | | | | | | | (1.5 lb/ream dry | |
| | | | | | | | | coating on PET)- | |
| | | | | | | | | 0 no adhesion, | |
| | | | | Final | | Final Dry Solid | | 100 good adhesion | |
| | | | | Mixture | | Part A | | Primer | 400A to |
| | | | | Part | Part | (Fluoropolymer | Part | Adhesion | Primer |
| Part A | Solid | Part B | Solid | A | B | dry wt %) | B | to PET | Adhesion |
| 400A | 48.0% | Functional | 31.60% | 100 | 0 | 100% | 0% | 0 | 100 |
| Dispersion | 48.0% | A | 31.60% | 95 | 5 | 97% | 3% | 0 | 100 |
| (Fluoropolymer | 48.0% | dispersion | 31.60% | 85 | 15 | 90% | 10% | 0 | 100 |
| Dispersion) | 48.0% | | 31.60% | 70 | 30 | 78% | 22% | 0 | 100 |
| | 48.0% | | 31.60% | 50 | 50 | 60% | 40% | 100 | 100 |
| | 48.0% | | 31.60% | 40 | 60 | 50% | 50% | 100 | 100 |
| | 48.0% | | 31.60% | 30 | 70 | 39% | 61% | 100 | 100 |
| | 48.0% | | 31.60% | 20 | 80 | 28% | 72% | 100 | 0 |
| | 48.0% | | 31.60% | 10 | 90 | 14% | 86% | 100 | 0 |
| | 48.0% | | 31.60% | 5 | 95 | 7% | 93% | 100 | 0 |
| | 48.0% | | 31.60% | 0 | 100 | 0% | 100% | 100 | 0 |

As illustrated in Table 4, ratios of the fluoropolymer dispersion 400A to the functionalized dispersion A from about 50/50 to about 30/70 demonstrated good adhesion to both the PET thermoplastic film and the 400A fluoropolymer coating.

In accordance with the foregoing testing procedure, primer compositions including various ratios of functionalized dispersion “B” and fluoropolymer dispersion “400A” were tested for adhesion. The testing and results are summarized in Table 5.

TABLE 5
400A/Dispersion B
Primer Adhesion Evaluation based on 400A and Functional B dispersion

| | | | | | | | | Final Mixture Dry | |
|---|---|---|---|---|---|---|---|---|---|
| | | | | | | | | Coating Evaluation | |
| | | | | | | | | (1.5 lb/ream dry | |
| | | | | | | | | coating on PET)- | |
| | | | | | | | | 0 no adhesion, | |
| | | | | Final | | Final Dry Solid | | 100 good adhesion | |
| | | | | Mixture | | Part A | | Primer | 400A to |
| | | | | Part | Part | (Fluoropolymer | Part | Adhesion | Primer |
| Part A | Solid | Part B | Solid | A | B | dry wt %) | B | to PET | Adhesion |
| 400A | 48.0% | Functional | 27.00% | 100 | 0 | 100% | 0% | 0 | 100 |
| Dispersion | 48.0% | B | 27.00% | 92 | 8 | 95% | 5% | 0 | 100 |
| (Fluoropolymer | 48.0% | dispersion | 27.00% | 76 | 24 | 85% | 15% | 0 | 100 |
| Dispersion) | 48.0% | (Polyester) | 27.00% | 63 | 37 | 75% | 25% | 100 | 100 |
| | 48.0% | | 27.00% | 51 | 49 | 65% | 35% | 100 | 100 |
| | 48.0% | | 27.00% | 41 | 59 | 55% | 45% | 100 | 100 |
| | 48.0% | | 27.00% | 32 | 68 | 45% | 55% | 100 | 100 |
| | 48.0% | | 27.00% | 23 | 77 | 35% | 65% | 100 | 0 |
| | 48.0% | | 27.00% | 16 | 84 | 25% | 75% | 100 | 0 |
| | 48.0% | | 27.00% | 9 | 91 | 15% | 85% | 100 | 0 |
| | 48.0% | | 27.00% | 3 | 97 | 5% | 95% | 100 | 0 |
| | 48.0% | | 27.00% | 0 | 100 | 0% | 100% | 100 | 0 |

As illustrated in Table 5, ratios of the fluoropolymer dispersion 400A to the functionalized dispersion B from about 63/37 to about 32/68 demonstrated good adhesion to both the PET thermoplastic film and the 400A fluoropolymer coating.

In accordance with the foregoing testing procedure, primer compositions including various ratios of functionalized dispersion “C” and fluoropolymer dispersion “400A” were tested for adhesion. The testing and results are summarized in Table 6.

TABLE 6
400A/Dispersion C
Primer Adhesion Evaluation based on 400A and Functional C dispersion

| | | | | | | | | Final Mixture Dry | |
|---|---|---|---|---|---|---|---|---|---|
| | | | | | | | | Coating Evaluation | |
| | | | | | | | | (1.5 lb/ream dry | |
| | | | | | | | | coating on 5 mil | |
| | | | | | | | | Polycarbonate Film)- | |
| | | | | | | | | 0 no adhesion, | |
| | | | | Final | | Final Dry Solid | | 100 good adhesion | |
| | | | | Mixture | | Part A | | Primer | 400A to |
| | | | | Part | Part | (Fluoropolymer | Part | Adhesion | Primer |
| Part A | Solid | Part B | Solid | A | B | dry wt %) | B | to PC film | Adhesion |
| 400A | 48.0% | Functional C | 30.00% | 100 | 0 | 100% | 0% | 0 | 100 |
| Dispersion | 48.0% | dispersion | 30.00% | 92 | 8 | 95% | 5% | 0 | 100 |
| (Fluoropolymer | 48.0% | (Polyurethane) | 30.00% | 78 | 22 | 85% | 15% | 0 | 100 |
| Dispersion) | 48.0% | | 30.00% | 65 | 35 | 75% | 25% | 0 | 100 |
| | 48.0% | | 30.00% | 54 | 46 | 65% | 35% | 100 | 100 |
| | 48.0% | | 30.00% | 43 | 57 | 55% | 45% | 100 | 100 |
| | 48.0% | | 30.00% | 34 | 66 | 45% | 55% | 100 | 100 |
| | 48.0% | | 30.00% | 25 | 75 | 35% | 65% | 100 | 0 |
| | 48.0% | | 30.00% | 17 | 83 | 25% | 75% | 100 | 0 |
| | 48.0% | | 30.00% | 10 | 90 | 15% | 85% | 100 | 0 |
| | 48.0% | | 30.00% | 3 | 97 | 5% | 95% | 100 | 0 |
| | 48.0% | | 30.00% | 0 | 100 | 0% | 100% | 100 | 0 |

As illustrated in Table 6, ratios of the fluoropolymer dispersion 400A to the functionalized dispersion C from about 54/46 to about 34/66 demonstrated good adhesion to both the PC thermoplastic film and the 400A fluoropolymer coating.

In accordance with the foregoing testing procedure, primer compositions including various ratios of functionalized dispersion “D” and fluoropolymer dispersion “FE-4300” were tested for adhesion. The testing and results are summarized in Table 7.

TABLE 7
FE-4300/Dispersion D
Primer Adhesion Evaluation based on AGC Lumiflon FE 4300 and Functional D dispersion

| | | | | | | | | Final Mixture Dry | |
|---|---|---|---|---|---|---|---|---|---|
| | | | | | | | | Coating Evaluation | |
| | | | | | | | | (1.5 lb/ream dry | |
| | | | | | | | | coating on 5 mil | |
| | | | | | | | | Polycarbonate Film)- | |
| | | | | | | | | 0 no adhesion, | |
| | | | | | | | | 100 good adhesion | |
| | | | | | | | | Primer | |
| | | | | Final | | Final Dry Solid | | Adhesion | |
| | | | | Mixture | | Part A | | to PET | FE4300 |
| | | | | Part | Part | (Fluoropolymer | Part | (or PVC) | to Primer |
| Part A | Solid | Part B | Solid | A | B | dry wt %) | B | film | Adhesion |
| AGC Lumiflon | 50.0% | Functional D | 40.0% | 100 | 0 | 100% | 0% | 0 | 100 |
| FE4300 coating | 50.0% | dispersion | 40.0% | 88 | 12 | 90% | 10% | 0 | 100 |
| (Fluoropolymer | 50.0% | (Polyurethane) | 40.0% | 76 | 24 | 80% | 20% | 0 | 100 |
| Emulsion) | 50.0% | | 40.0% | 65 | 35 | 70% | 30% | 0 | 100 |
| | 50.0% | | 40.0% | 55 | 45 | 60% | 40% | 100 | 100 |
| | 50.0% | | 40.0% | 44 | 56 | 50% | 50% | 100 | 100 |
| | 50.0% | | 40.0% | 35 | 65 | 40% | 60% | 100 | 0 |
| | 50.0% | | 40.0% | 25 | 75 | 30% | 70% | 100 | 0 |
| | 50.0% | | 40.0% | 17 | 83 | 20% | 80% | 100 | 0 |
| | 50.0% | | 40.0% | 8 | 92 | 10% | 90% | 100 | 0 |
| | 50.0% | | 40.0% | 4 | 96 | 5% | 95% | 100 | 0 |
| | 50.0% | | 40.0% | 0 | 100 | 0% | 100% | 100 | 0 |

As illustrated in Table 7, ratios of the fluoropolymer dispersion FE-4300 to the functionalized dispersion D from about 55/45 to about 44/56 demonstrated good adhesion to both the PET (or PVC) thermoplastic film and the FE-4300 fluoropolymer coating.

Accordingly, it has been shown that the functional polymer amount in the primer layer (layer 14 of the FIGURE) controls the adhesion to the thermoplastic film (layer 16 of the FIGURE) while fluoropolymer amount controls the primer layer adhesion to fluoropolymer top coat (layer 12 of the FIGURE). The fluorpolymer dry loading range for the primer layer is therefore from about 28% to about 85%, with a preferred range of about 39% to about 75%, and with a most preferred range of about 50% to about 60%. The normal primer layer coating weight may range from about 0.2 lb/ream to about 2.0 lb/ream, with a preferred range of about 0.5 lb/ream to about ⅕ lb/ream, and with a most preferred range from about 0.8 lb/ream to about 1.2 lb/ream.

Accordingly, embodiments of the present disclosure provide compatible blends of functionalized polymer (namely the carboxyl or hydroxyl group in polyurethane, polyester, EAA) dispersions with non-functional fluoropolymer dispersion at defined ratios to create a primer layer that will adhere to both a thermoplastic film (polyester, PC, PVC, etc.) and a non-functional fluoropolymer coating. It is expected that the described embodiments will increase the application of fluoropolymer coatings on various thermoplastic substrates without the need to copolymerize a functional group in the main fluoropolymer chain of the fluoropolymer coatings.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the application in any way. Rather, the foregoing detailed description will provide those skilled in the art with a convenient road map for implementing one or more embodiments, it being understood that various changes may be made in the function and arrangement of elements described in an exemplary embodiment without departing from the scope, as set forth in the appended claims.

What is claimed is:

1. A multilayer film comprising:
a) a thermoplastic polymer layer having a first surface and a second surface opposed to the first surface;
b) a primer layer in contact with the first surface of the thermoplastic polymer layer, said primer layer comprising a fluoropolymer and a functionalized polymer; and
c) a fluoropolymer layer having a first surface, and a second surface opposed to the first surface, the fluoropolymer layer being attached to the thermoplastic polymer layer such that the primer layer is positioned in contact with the first surface of the fluoropolymer layer and the first surface of the thermoplastic polymer layer.

2. The multilayer film of claim 1 wherein said thermoplastic polymer layer comprises a polyolefin homopolymer, a polyolefin copolymer, a cyclic olefin homopolymers, a cyclic olefin copolymer, an ethylene vinyl acetate copolymer, a polyester, a polyamide, polyvinyl chloride, polyvinylidene chloride, polystyrene, a styrenic copolymer, polyisoprene, a polyurethane, ethylene ethyl acrylate, an ethylene acrylic acid copolymer, a fluoropolymer, or mixtures thereof.

3. The multilayer film of claim 1 wherein said thermoplastic polymer layer comprises polyethylene terephthalate or polyvinylidene chloride.

4. The multilayer film of claim 1 wherein said fluoropolymer layer comprises a polychlorotrifluoroethylene.

5. The multilayer film of claim 4 wherein said fluoropolymer layer further comprises a vinylidene fluoride.

6. The multilayer film of claim 5 wherein said fluoropolymer layer is a copolymer of polychlorotrifluoroethylene and vinylidene fluoride.

7. The multilayer film of claim 1 wherein said functionalized polymer comprises an acrylic polymer.

8. The multilayer film of claim 7 wherein said functionalized polymer further comprises a urethane polymer.

9. A packaging article formed from the multilayer film of claim 1.

10. The packaging article of claim 9 enclosing a packaged product.

11. A process for producing a multilayer film comprising the steps of:
a) providing a thermoplastic polymer layer having a first surface, and a second surface opposed to the first surface;
b) applying an primer layer onto the first surface of the thermoplastic polymer layer, said primer layer comprising a fluoropolymer and a functionalized polymer; and
c) applying a fluoropolymer layer, having a first surface, and a second surface opposed to the first surface, to the thermoplastic polymer layer, such that the primer layer is positioned in contact with the first surface of the fluoropolymer layer and the first surface of the thermoplastic polymer layer.

12. The process of claim 11 wherein said thermoplastic polymer layer comprises a polyolefin homopolymer, a polyolefin copolymer, a cyclic olefin homopolymers, a cyclic olefin copolymer, an ethylene vinyl acetate copolymer, a polyester, a polyamide, polyvinyl chloride, polyvinylidene chloride, polystyrene, a styrenic copolymer, polyisoprene, a polyurethane, ethylene ethyl acrylate, an ethylene acrylic acid copolymer, a fluoropolymer, or mixtures thereof.

13. The process of claim 11 wherein said thermoplastic polymer layer comprises polyethylene terephthalate or polyvinylidene chloride.

14. The process of claim 11 wherein said fluoropolymer layer comprises a polychlorotrifluoroethylene.

15. The process of claim 14 wherein said fluoropolymer layer further comprises a vinylidene fluoride.

16. The process of claim 15 wherein said fluoropolymer layer is a copolymer of polychlorotrifluoroethylene and vinylidene fluoride.

17. The process of claim 11 wherein said functionalized polymer comprises an acrylic polymer.

18. The process of claim 17 wherein said functionalized polymer further comprises a urethane polymer.

19. The process of claim 11, further comprising forming a packaging article from the multilayer film.

20. The process of claim 19, further comprising enclosing a packaged product within the packaging article.
